(19) United States
(12) Patent Application Publication
(10) Pub. No.: US 2008/0316049 A1
(43) Pub. Date: Dec. 25, 2008

(54) RFID Tag Tracer Method and Apparatus

(75) Inventors: Robin J. Verret, Youngsville, LA (US); Michael J. Kilchrist, Lafayette, LA (US)

Correspondence Address: LUNDEEN & LUNDEEN, PLLC, PO BOX 131144, HOUSTON, TX, 77219-1144, US

(73) Assignee: TURBO-CHEM INTERNATIONAL, INC., Scott, LA (US)

(21) Appl. No.: 12/145,726

(22) Filed: Jun. 25, 2008

Related U.S. Application Data
(60) Provisional application No. 60/945,968, filed on Jun. 25, 2007.

(51) Int. Cl. G01V 3/00

(52) U.S. Cl. 340/854.6

(57) ABSTRACT

A fluid can be tracked in a wellbore utilizing at least one RFID tag entrained in the fluid. An RFID tag reader can be disposed and/or displaced in the wellbore, for example, on a drill string or a casing string. A reader can be utilized to locate the at least one RFID tag in the wellbore. A reader can be housed in a drill string sub. A fluid entrained with at least one RFID tag can be utilized as a tracer fluid. An RFID tag can be entrained in cement or a drilling or fracture fluid.

### BACKGROUND

The invention relates generally to an apparatus and method to track a fluid with at least one electronic tracking device entrained therein; or more particularly, with at least one radio frequency identification (RFID) tag entrained therein.

It can be desirable to track a fluid in a wellbore, e.g., a wellbore in a formation for the recovery of hydrocarbons. Tracking a fluid can include determining the location of a fluid loss zone and/or the location of a fluid itself, e.g., drilling mud, cement, etc., in the wellbore. One way of identifying a possible location of a loss zone, e.g., lost circulation, is to use a noise log, which measures any increase in movement or activity in a wellbore based on the change in tone or volume in the noise of flowing fluid at a certain depth, using specialized logging tools. Another method of identifying a possible location of a loss zone, as well as evaluating a cement or hydraulic fracture treatment, is to use a temperature log, which measures changes and/or variance in temperature, again using specialized logging equipment. Both of these methods can be imprecise and/or fail their intended purpose.

A tracer which has been used for decades is a radioactive isotope in, most commonly, powdered form and placed in a carrier fluid and pumped down hole. The location of the radioactivity is searched, for example, to determine an exit point or concentration somewhere in the wellbore. In the U.S., for example, stringent Occupational Safety & Health Administration (OSHA) and/or environmental regulations can impede use of radioactive tracers.

### SUMMARY OF THE INVENTION

An RFID tag can be entrained in a fluid to allow tracking of the fluid within a wellbore. In one embodiment, a method of tracking a fluid, which can be in a wellbore, can include entraining at least one electronic tracking device in the fluid; and tracking the electronic tracking device with at least one receiver. A method of tracking a fluid, which can be in a wellbore, can include entraining at least one radio frequency identification (RFID) tag in the fluid, and locating the at least one RFID tag in the wellbore with at least one reader.

The method can include injecting a slurry of the at least one RFID tag and the fluid into the wellbore. The method can include injecting a slurry of the at least one RFID tag and the fluid into an annulus between an outer surface of a first casing string disposed in the wellbore and at least one of the wellbore and an inner surface of a second casing string circumferential to the first casing string. The method can include determining when the fluid is injected to a desired location in the annulus and/or wellbore. The method can include injecting a slurry of the at least one RFID tag and the fluid into an annulus between an outer surface of a drill string and the wellbore. The method can include disposing and/or displacing the at least one reader in the wellbore. The method can include disposing the at least one reader in the wellbore on a drill string.

The entraining step can include entraining a plurality of RFID tags in the fluid. The method can include detecting a fluid loss by locating a concentrated zone of the plurality of RFID tags in the wellbore. The method can include entraining the plurality of RFID tags substantially uniformly in the fluid. The method can include detecting a fluid void by locating a zone in the wellbore substantially devoid of the plurality of RFID tags. The method can include transmitting sensor data from the at least one RFID tag to the reader and/or writing data to the at least one RFID tag, e.g., with the reader.

In another embodiment, a drilling fluid composition can include a drilling fluid, and at least one RFID tag entrained in the drilling fluid.

In another embodiment, a fracturing fluid composition can include a fracturing fluid, and at least one RFID tag entrained in the fracturing fluid.

In yet another embodiment, a cement composition can include a cement, and at least one RFID tag entrained in the cement. The cement can be solidified or fluidic, e.g., during a pumping step.

In another embodiment, a tracer slug can include a fluid, and at least one RFID tag entrained in the fluid.

In yet another embodiment, a system to track a fluid, which can be in a wellbore, can include at least one RFID tag entrained in the fluid, and at least one reader. The at least one reader can be disposed within the wellbore. The at least one reader can be disposed on a drill string or a casing string.

In another embodiment, a drill string sub can include a sub body having at least one connection to a drill string, and at least one RFID tag reader disposed on the sub body.

### DETAILED DESCRIPTION OF THE INVENTION

The invention relates generally to an apparatus and method of tracking a fluid in a wellbore with at least one electronic tracking device entrained therein; or more particularly, with at least one radio frequency identification (RFID) tag entrained therein. Generally, an RFID tag is a device that transmits identification information to a reader, also referred to as an interrogator. RFID tags typically include an antenna and means to transmit a signal corresponding to a data representation, e.g., a microchip or piezoelectric crystals with reflectors on the surface thereof. RFID technology was previously claimed in U.S. Pat. No. 3,054,100, herein incorporated by reference.

There are several methods of identification, including, but not limited to, storing a serial number that identifies the RFID tag. A reader can convert radio waves reflected back from the RFID tag into digital information, e.g., the serial number or other information such as, but not limited to, depth, direction, GPS location, pressure, temperature, velocity, acceleration, radiation, etc., that can then be passed on, for example, to computer(s) that can make use of it. A reader can operate in real-time and/or as needed. An RFID tag can be in communication with a sensor or include a sensor therewith, for example, to measure depth, direction, GPS location, pressure, temperature, velocity, acceleration, radiation, etc. GPS location of a drilling fluid via entrained RFID tag(s) can be utilized, for example, in directional drilling control.

An RFID tag, including a microchip, piezoelectric crystal, and/or antenna thereof, can be encapsulated, for example, in a housing, e.g., spherical, and/or resin, such as epoxy. An antenna can extend within an encapsulation material and/or externally from an encapsulation material. The encapsulation material(s) can be a polymer, e.g., plastic. Encapsulation material can have a low dielectric constant, for example, less than about 20, 10, 0.1, 0.01, 0.001, 0.0001, 0.00001, or any range therein. Encapsulation material(s) can be malleable and/or resilient. The encapsulation material(s) can include, but is not limited to, those measured on the Shore A or B durometer hardness scale. An encapsulation material can have a Shore A or B hardness of about 0, 1, 5, 10, 15, 20, 25, 30, 35, 40, 45, 50, 55, 60, 65, 70, 75, 80, 85, 90, 95, 100, or any range therein. An encapsulation material can be relatively softer than the pumping surface of a pump transporting a slurry of fluid and RFID tag(s), e.g., to minimize damage to the pump and/or RFID tag(s).

The size of an RFID tag, including a microchip, piezoelectric crystal, and/or antenna(e), can be design selected. Miniaturized embodiments developed by Hitachi, Ltd. include an RFID microchip that is 0.05 millimeters square and 5 microns thick and another that is 0.4 millimeters square and 0.12 millimeters thick. The concentration of RFID tags in a fluid can be design selected. RFID tags can be safer and/or more accurate than other tracking methods.

RFID tags can be active, passive, or even semi-passive. An active RFID tag typically includes a battery to power a microchip's circuitry and to broadcast a signal to a reader. Passive tags typically have no battery, but draw power from electromagnetic waves emanating from the reader that induce a current in the tag's antenna. Semi-passive RFID tags typically use a battery to run the microchip's circuitry, but communicate by drawing power from the reader.

RFID tags can be read-only or read and/or write tags. Writing and/or reading of data to an RFID tag is know to one of ordinary skill in the art. In one embodiment, an RFID tag can include memory to store data, e.g., until it is transmitted to a reader. An RFID tag can include a sensor automatically writing data to the memory of the RFID tag. RFID tag(s) with an appropriate read range (e.g., distance between RFID tag and reader) can be selected. RFID tag(s) with a desired frequency of use can be selected, for example, low (about 125 KHz), high (about 13.6 MHz), ultra high frequency (UHF) (about 850 to about 900 MHz), or microwave (about 2.45 GHz). Writing data can include marking those RFID tags disposed in a location of interest. For example, RFID tags in a zone of high RFID tag concentration, which can indicate a loss zone, can be marked such that one can specifically track those RFID tags, e.g., if they migrate from and/or within the loss zone.

An RFID tag can include, but is not limited to, an integrated circuit (IC) type of tag and/or a surface acoustic wave (SAW) type of tag. An IC based tag, e.g., a transponder and backscatter tag, can include a microelectronic semiconductor device comprising interconnected transistors. A SAW based tag can include passive crystal devices. In one embodiment, a SAW tag utilizes piezoelectric crystals with reflectors at pre-determined intervals or locations to represent the tag's data, which can be read by variations in amplitude, time, phase and/or other variables. When incoming radio energy is transmitted along the surface of the SAW tag, each reflector reflects part of the signal back. The spacing of these reflections, i.e., echoes, indicates the location and relative position of each reflector of that tag. The position of each reflector can then be calculated and translated into a data representation, e.g., corresponding to an identification number. SAW types of tags can be read through drilling mud, sea water, bromides, chlorine, and cement, for example. SAW types of tags can withstand temperatures up to about 400° C. (752° F.) and pressures up to about 140,000,000 Pa (20,000 psi).

At least one RFID tag can be entrained in a fluid, which can be a liquid and/or a gas. Entraining can include suspending or substantially suspending an RFID tag(s) in the fluid. For example, an RFID tag can have the same or substantially the same density as the fluid. A plurality of RFID tags can be entrained in the fluid, e.g., substantially uniformly entrained. RFID tags can be at a concentration of about 1, 10, 20, 50, 100, 1000, 5000, 10000, 100000, 1000000 per cubic meter of fluid. A suitable concentration of RFID tags to utilize in a fluid can be determined from tolerable loss volumes of fluid. In one embodiment, the number of RFID tags in a fracture or other fluid loss zone depends on the volume of leak rate, the concentration of RFID tags in the carrier fluid, and the amount of time; assuming all or most of the tags can be detected or read during entry or after deposition in the fracture, the number of tags detected can correlate with the amount of fluid lost.

An RFID tag(s) can be added to the fluid before it is in the wellbore, for example, at least one RFID tag and the fluid can be mixed, e.g., at the surface, to form a slurry. The slurry can be pumped or otherwise disposed into the wellbore. For example, RFID tag(s) can be released, e.g., from a downhole sub, into the fluid. A fluid and/or RFID tag can be design selected to allow substantially uniform entrainment and/or suspension in a dynamic and/or static fluid. The RFID tags can be continuously present in a drilling mud while drilling commences for more or less continuous or periodic loss zone monitoring, in an embodiment, the RFID tags are continuously added to the drilling mud, e.g. to make up for lost or damaged tags in the recirculated mud. Alternatively or additionally, the RFID tags can be used in a pill or slug of fluid used to locate the thief zone. If desired, “used” RFID tags can be recovered for re-use from the fluid upon return to the surface by screening, magnetic separation, flotation, or other physical separation process.

A fluid to entrain an RFID tag(s) can comprise a drilling mud, including, but not limited to oil base and synthetic base fluids. A fluid with a low dielectric constant, i.e., the ratio of the permittivity of a medium to that of free space, can increase the transmit range and/or read range of an RFID tag or reader. An oil and/or synthetic based fluid, e.g., drilling fluid, can have a low dielectric constant. Oil has a dielectric constant of about 2.1 at 20° C. (68° F.), air about 1, and water about 80 at 26.7° C. (80° F.). Oil and water emulsions generally have a mixture dielectric constant between water (80) and oil (2), depending on the oil and water content and whether the mixture is oil-continuous (invert emulsion) or water-continuous, as described in U.S. Pat. No. 6,182,504 to Gaisford incorporated herein by reference. This means that the RFID tagging to locate lost circulation zones is more effective in oil based or synthetic drilling fluids which are generally more expensive and less desirable to lose than aqueous-based drilling fluids. In embodiments, a fluid can have, but is not limited to, a dielectric constant less than about 80, 50, 30, 20, 15, 10, 5, 3, 2.5, 2.1, 2, 1, 0.1, 0.01, 0.001, or any range therein.

A fluid can be selected with a dielectric constant less than water, air, or oil, e.g., to increase transmit range and/or read range of an RFID tag or reader. By taking the dielectric constant of the fluid into account the reader can process the signal from the RFID tag to determine the distance of the RFID tag from the reader, in an embodiment. For example, the reader can include a sensor of the type in U.S. Pat. No. 6,182,504 to Gaisford in an embodiment to determine the electrical properties of the fluid.

In one embodiment, an RFID tag(s) is entrained in the fluid, and the slurry of the fluid and RFID tag(s) can be injected into the wellbore. As used herein, wellbore can refer to a bore hole formed in a formation and/or any tubulars or other apparatus disposed at least partially within the bore hole. A wellbore can include at least one casing string therein, as is known the art.

In one embodiment, at least one RFID tag is entrained in a fluid in a wellbore. A fluid having at least one RFID tag can be tracked in the wellbore by utilizing at least one reader. The location of the RFID tag can be determined with a reader or a plurality of readers. It is appreciated that a reader and/or RFID tag can be thousands of feet below the surface. Locating can include physical location and/or location relative to a given time. Locating can include determining when and/or if an RFID tag is read by a reader, e.g., the RFID tag transmits a signal to a reader. It is appreciated that a plurality of embodiments are possible, including, but not limited to, those with static and/or dynamically displaced reader(s) and static and/or dynamically displaced RFID tag(s). At least one RFID tag entrained in a fluid can allow inventory tracking of the fluid itself, for example, fluid in mud pits, and not a container.

A reader can be stationary or dynamically moved within the wellbore. A reader can be disposed in the wellbore, for example, on a wireline cable or on an outer surface of, in a wall of, and/or in the bore of a drill string, casing string, or other conduit. A plurality of readers can be disposed along an axial length and/or circumference of a wireline cable, drill string, or casing string, for example. A casing string can be stationary in the wellbore. A drill string can be stationary in the wellbore, operated according to typical drilling practices, or dynamically moved, e.g., displaced, along a predrilled section of wellbore. A reader can be displaced along an axial length of a drill string or casing string. A reader can be encapsulated, for example, in a housing and/or resin, such as epoxy. Encapsulation material can have a low dielectric constant, for example, less than about 20, 10, 5, 2, 1, 0.1, 0.01, 0.001, 0.0001, 0.00001, or any range therein.

A signal broadcast from an RFID tag can be read by a reader disposed at the surface, e.g., stationary. Alternatively or additionally, a reader disposed in the wellbore can read the signal broadcast by an RFID tag and transmit the identification information corresponding to the RFID tag to the surface, e.g., by wireline, or store the information as a log, which can be read on return to the surface.

In one embodiment, a reader can be disposed adjacent a location of interest, e.g., an outlet or distal end, of a drill string, casing string, or conduit to allow the reading of an RFID tag, for example, if an RFID tag entrained in fluid is proximate to the reader. One specific, non-limiting application of this can be if the fluid is motive, the reader can determine the presence of an RFID tag passing within its read range, and thus function as a tracer to track the fluid having the RFID tag entrained therein. A reader can be disposed on and/or within a sub, which can be connected to a drill string, so as to be compatible with a bottom hole assembly. A reader can be a component unitary to a bottom hole assembly. Communication between the reader and a surface location can be achieved, for example, by mud pulse technology, wireline, fiber optic, or any other downhole communication and/or data transmission methods known in the art. Alternatively or additionally, the reader can record a log of RFID readings that is read when the reader is retrieved at the surface in an embodiment.

In one embodiment, a plurality of readers can be disposed throughout a wellbore, including a bore and/or outer surface of a drill string, casing string, or other tubular disposed in the wellbore. In such an embodiment, the plurality of readers can utilize a known location of each reader to determine location of any RFID tag entrained in the fluid. For example, if the fluid is flowing through the wellbore, the movement of the fluid can be ascertained as the location of the RFID tag, e.g., at a specific time, is known. Movement of an RFID tag, which can closely approximate the movement of the carrier fluid itself, can be used to determine velocity, acceleration, etc.

In one embodiment, a plurality of RFID tags can be added to a fluid in the wellbore, for example, a drilling fluid pumped from the surface. Drilling fluid with entrained RFID tags can be tracked within the bore of a drill string it is pumped through (e.g., by including at least one reader in the bore of the drill string) and/or tracked within an annulus formed between the outer surface of the drill string and the wellbore (e.g., by including at least one reader in the annulus).

An RFID tag, or tags, entrained in a fluid can be used as a tracer. For example, a fluid entrained with RFID tag(s) can be utilized as a tracer slug, e.g., injected into another fluid, or the fluid entrained with RFID tag(s) itself can be the fluid whose location, etc. is ascertained. In one embodiment, a reader can be disposed in the wellbore and utilized to determine when and/or if the fluid with entrained RFID tag(s) reaches the location of the reader (e.g., read range). For example, a reader can be disposed at one location, and the time it takes an RFID tag(s) entrained in fluid to flow from a first location, e.g., the surface, to the reader can be determined. Circulation time, etc., can be determined from this time measurement. Tracking an RFID tag(s) can allow tracking of fluid paths and/or fluid velocity. If an RFID tag(s) can be disposed into the formation, e.g., through a wall of the wellbore, the RFID tag(s) can be utilized to later identify a core(s) and/or fluid(s) sampled from the formation. Other tracer methods known in the art can be utilized with this novel entrained RFID tag tracking method without departing from the spirit of the invention.

At least one RFID tag entrained in a fluid in the wellbore can be used to detect a fluid loss, e.g., an area of the wellbore where circulation is lost. Such methods can be used to evaluate a hydraulic fracture treatment. If there is a fluid loss from a wellbore, an RFID tag entrained in the fluid in wellbore can flow into (e.g., if the RFID tag is of appropriate size relative to the fluid loss aperture or opening) or at least adjacent to, the zone of fluid loss in the wellbore. At least one reader can then be utilized to locate the RFID tag, which in that embodiment corresponds to the fluid loss.

In another embodiment, a plurality of RFID tags can be entrained within a fluid in the wellbore and the RFID tags can flow into (e.g., if the RFID tag is of appropriate size relative to the fluid loss aperture or opening) or at least adjacent to, the zone of fluid loss in the wellbore. At least one reader can then be utilized to locate a concentrated zone of RFID tags, which in that embodiment will correspond to an area, or areas, of fluid loss.

Locating an RFID tag can include displacing a reader within the wellbore until the RFID tag is located, e.g., as the depth of the reader can be known. Additionally or alternatively, a plurality of readers can be disposed and/or displaced in the wellbore. For example, a plurality of readers can be disposed on the inner and/or outer surface of a drill string, a casing string, or other conduit in the wellbore.

In one particular embodiment, a drill string can have a plurality of readers disposed along an inner and/or outer surface of the drill string, e.g., to read radially and/or axially, and the concentrated zone of RFID tags can be located without displacing the drill string along a length of wellbore. However, a drill string can be displaced radially and/or axially, with the readings converted into geostationary location(s) through standard methods known in the art, e.g., knowing the rate of rotation and/or axially displacement of the drill string. Such an embodiment can allow for a depth and/or azimuth reading corresponding to a particular RFID tag to be ascertained.

Additionally or alternatively, at least one RFID tag entrained in a fluid in the wellbore can be used to detect a fluid void, e.g., an area of the wellbore where the particular fluid is not present. If there is a fluid void in a wellbore, no RFID tag will be located in that zone. At least one reader can be utilized to locate the areas lacking an RFID tag, which in that embodiment will correspond to the fluid void.

In one particular, non-limiting example, a plurality of RFID tags can be entrained within a fluid in the wellbore, (e.g., cement or a well treatment fluid). At least one reader can be utilized to locate a zone devoid, or substantially devoid, or RFID tags, which in that embodiment will correspond to an area, or areas, devoid of the fluid, i.e. free of lost circulation zones. Locating an RFID tag can include disposing a single reader within the wellbore until the devoid areas are located, e.g., as the depth of the reader can be known. Additionally or alternatively, a plurality of readers can be disposed and/or displaced in the wellbore. For example, a plurality of readers can be disposed on the inner and/or outer surface of a drill string, a casing string, or other conduit in the wellbore.

In one particular embodiment, a casing string can be disposed in a wellbore for cementing, as is known the art. The casing string, or a separate drill string or tubular (e.g., production tubing), can have a plurality of readers disposed along an inner and/or outer surface thereof, e.g., to read radially and/or axially. A fluid, e.g., cement, can be pumped into the wellbore, or more particularly, the annulus between the outer surface of the casing string and the wellbore and/or any other casing string which may be present. A reader or readers can be utilized to locate any areas devoid of RFID tags, which will correspond to areas devoid of cement in this location as the RFID tags are entrained in the cement. This can be useful, for example, to identify if a sufficient bond between the casing and the wellbore is formed and/or if the cement did not reach the desired area of the annulus. A plurality of RFID tags disposed throughout solidified cement can allow monitoring of the solidified cement, e.g., by locating any areas devoid of RFID tags which can correspond to an area devoid of cement.

As discussed above, RFID tag(s) can be located without displacing the reader along a length of wellbore. However, a reader can be displaced radially and/or axially, with the readings converted into geostationary location(s) through standard methods known in the art, e.g., knowing the rate of rotation and/or axially displacement of the reader. Such an embodiment can allow for a depth and/or azimuth reading corresponding to a particular RFID tag to be ascertained. Embodiments can include, but are not limited to, a moving reader and stationary and/or moving single RFID tag, a moving reader and stationary and/or moving plurality of RFID tags, a stationary reader and stationary and/or moving single RFID tag, and/or a stationary reader and a stationary and/or moving plurality of RFID tags. A reader can be displaced in and out of the wellbore, for example, as in a logging operation.

Numerous embodiments and alternatives thereof have been disclosed. While the above disclosure includes the best mode belief in carrying out the invention as contemplated by the named inventors, not all possible alternatives have been disclosed. For that reason, the scope and limitation of the present invention is not to be restricted to the above disclosure, but is instead to be defined and construed by the appended claims.

What is claimed is:

1. A method of tracking a fluid in a wellbore comprising:
entraining at least one radio frequency identification (RFID) tag in the fluid; and
locating the at least one RFID tag in the wellbore with at least one reader.

2. The method of claim 1 further comprising injecting a slurry of the at least one RFID tag and the fluid into the wellbore.

3. The method of claim 1 further comprising injecting a slurry of the at least one RFID tag and the fluid into an annulus between an outer surface of a first casing string disposed in the wellbore and at least one of the wellbore and an inner surface of a second casing string circumferential to the first casing string.

4. The method of claim 3 further comprising determining when the fluid is injected to a desired location in the annulus.

5. The method of claim 1 further comprising injecting a slurry of the at least one RFID tag and the fluid into an annulus between an outer surface of a drill string and the wellbore.

6. The method of claim 1 further comprising disposing the at least one reader into the wellbore.

7. The method of claim 6 further comprising displacing the at least one reader within the wellbore.

8. The method of claim 6 further comprising disposing the at least one reader in the wellbore on a drill string.

9. The method of claim 1 wherein the entraining step comprises entraining a plurality of RFID tags in the fluid.

10. The method of claim 9 further comprising detecting a fluid loss by locating a concentrated zone of the plurality of RFID tags in the wellbore.

11. The method of claim 9 further comprising entraining the plurality of RFID tags substantially uniformly in the fluid.

12. The method of claim 11 further comprising detecting a fluid void by locating a zone in the wellbore substantially devoid of the plurality of RFID tags.

13. The method of claim 1 further comprising transmitting sensor data from the at least one RFID tag to the reader.

14. The method of claim 1 further comprising writing data to the at least one RFID tag.

15. A drilling fluid composition comprising:
a drilling fluid; and
at least one RFID tag entrained in the drilling fluid.

16. A fracturing fluid composition comprising:
a fracturing fluid; and
at least one RFID tag entrained in the fracturing fluid.

17. A cement composition comprising:
a cement; and
at least one RFID tag entrained in the cement.

18. The cement composition of claim 17 wherein the cement is fluidic.

19. The cement composition of claim 17 wherein the cement is solidified.

20. A tracer slug comprising:
a fluid; and
at least one RFID tag entrained in the fluid.

21. A system to track a fluid in a wellbore comprising:
at least one RFID tag entrained in the fluid; and
at least one reader disposed within the wellbore.

22. The system of claim 21 wherein the at least one reader is disposed on a drill string.

23. The system of claim 21 wherein the at least one reader is disposed on a casing string.

24. A drill string sub comprising:
a sub body having at least one connection to a drill string; and
at least one RFID tag reader disposed on the sub body.
